(19) United States
(12) Patent Application Publication
(10) Pub. No.: US 2019/0241327 A1
(43) Pub. Date: Aug. 8, 2019

(54) AIR CONTACT REDUCER FOR FOOD STORAGE CONTAINERS

(71) Applicant: Alan Dale Loveridge, Marcellus, MI (US)

(72) Inventor: Alan Dale Loveridge, Marcellus, MI (US)

(21) Appl. No.: 15/889,172

(22) Filed: Feb. 5, 2018

(51) Int. Cl. B65D 43/02; A47J 47/10

(52) U.S. Cl. CPC B65D 43/022; A47J 47/10; B65D 2543/00092; B65D 2543/00851; B65D 2543/00296; B65D 2543/0037; B65D 2543/0049; B65D 2543/00194

(57) ABSTRACT

An air contact reducer for food storage is described herein. The air contact reducer may be a single piece of plastic. The air contact reducer may be round or rectangular to match the shape of a food container. The air contact reducer may include a knob or handle to help move the air contact reducer up or down (or back and forth in some cases) to reduce the air contact with food while the food is being stored.

### FIELD OF INVENTION

This application is in the field of food storage; specifically forming an air tight seal.

### BACKGROUND

Typical storage container lids are created using a vacuum seal. A vacuum seal may be mechanically complex and expensive. Additionally a vacuum seal may be lost or misplaced more easily. Another approach to storage may be using plastic bags, for example in cereal boxes. Plastic bags may get left open or not sealed tightly. Additionally, the plastic bags are unlikely to be reused more than once.

### SUMMARY

An air contact reducer for food storage is described herein. The air contact reducer may be a single piece of plastic. The air contact reducer may be round or rectangular to match the shape of a food container. The air contact reducer may include a knob or handle to help move the air contact reducer up or down (or back and forth in some cases) to reduce the air contact with food while the food is being stored.

### BRIEF DESCRIPTION OF THE DRAWINGS

FIG. 1 is an example of an air contact reducer;

FIG. 2 is an example of an air contact reducer in a tapered vertical storage container;

FIG. 3A is an example of a top view of an air contact reducer;

FIG. 3B is an example of a side view of an air contact reducer; and

FIG. 4 is an example of an air contact reducer for use on a solid object.

### DETAILED DESCRIPTION OF THE DRAWINGS

This invention is described in the following description with reference to the Figures, in which like reference numbers represent the same or similar elements. While this invention is described in terms of modes for achieving this invention's objectives, it will be appreciated by those skilled in the art that variations may be accomplished in view of these teachings without deviating from the spirit or scope of the present invention. The embodiments and variations of the invention described herein, and/or shown in the drawings, are presented by way of example only and are not limiting as to the scope of the invention.

Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

An air contact reducer for food storage may be a single piece of plastic. The air contact reducer may be round or rectangular to match the shape of a food container. The air contact reducer may include a knob or handle to help move the air contact reducer up or down (or back and forth in some cases) to reduce the air contact with food while the food is being stored.

When food (or beverages) in a large storage container goes down, for example, eaten or consumed, the air contact reducer may be pushed down to match the level of food (or beverage) in the storage container. For example, when using a tall tapered container, the outer diameter may be thin around 0.020 inches for about 0.5-1.5 inches that has cuts about every 0.5 inches. The remainder of the air contact reducer may be thicker, for example, 0.125 inches or more. The air contact reducer may adjust in size by changing the diameter.

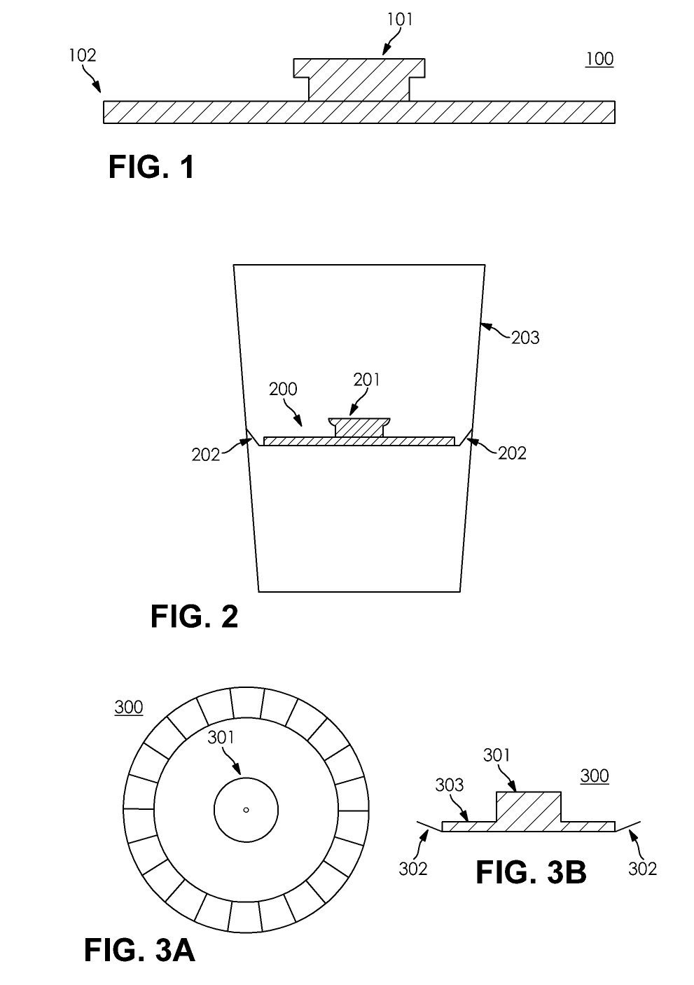

FIG. 1 is an example of an air contact reducer. The air contact reducer 100 may include a handle 101. The air contact reducer 100 of FIG. 1 may be used in a non-tapered container. For use in a non-tapered container, the air space reducer 100 may have no cuts on its edge, resulting in an almost vertical outer edge 102. The almost vertical outer edge 102 may be thin, but this edge provides the seal between the air contact reducer 100 and a storage container.

FIG. 2 is an example of an air contact reducer in a tapered vertical storage container. The storage container 203 may be, for example, a tapered cylinder or any other tapered shape. In this example, an air contact reducer 200 may be inserted into the storage container 203. A handle 201 may be used to push the air contact reducer 200 further into the storage container 203 as more of the contents of the storage container 203 is consumed. The air contact reducer 200 may have a thin outer diameter 202 with cuts at equivalent distances to allow the air contact reducer 200 to conform to the tapered shape of the storage container 203.

For example, the thin outer diameter may be 0.020 inches for anywhere from 0.5 inches to 1.5 inches with cuts about every 0.5 inches. The remainder of the air contact reducer 205 may be thicker, for example, 0.125 inches or more. The main diameter of the air contact reducer 200 may adjust in size to form an air tight seal in the storage container 203. In a tall tapered storage container, like storage container 203, as the air contact reducer 200 moves down the storage container the thin sections begin pointing more and more upward. A small amount of slipping may occur at the thin sections.

In another example of the air contact reducer in a non-tapered container, the air contact reducer may not have taper cuts. The air contact reducer may have a thickness of 0.125 inches or more.

FIG. 3A is an example of a top view of an air contact reducer. The air contact reducer 300 may be, for example a circle. However, the air contact reducer 300 may vary based on the shape of the storage container or solid object it is being used for, for example, a square, a rectangle, or the like. The air contact reducer may be made of plastic, rubber, or any other pliable material. The air contact reducer 300 may include a handle 301. The handle 301 may be a circle, square, or other similar shape that is easy to grip. In FIG. 3A, the air contact reducer 300 appears to be a uniform circle, however, because the thickness of the air contact reducer 300 may vary, the side view may look less uniform as illustrated in FIG. 3B.

FIG. 3B is an example of a side view of an air contact reducer. The air contact reducer 300 may include a handle 301. The air contact reducer 300 may have a thin outer diameter 302 with cuts at equivalent distances to allow the air contact reducer 300 to conform to the tapered shape of the storage container. The remainder of the air contact reducer 303 may be thicker. The main diameter of the air contact reducer 200 may adjust in size to form an air tight seal in the storage container.

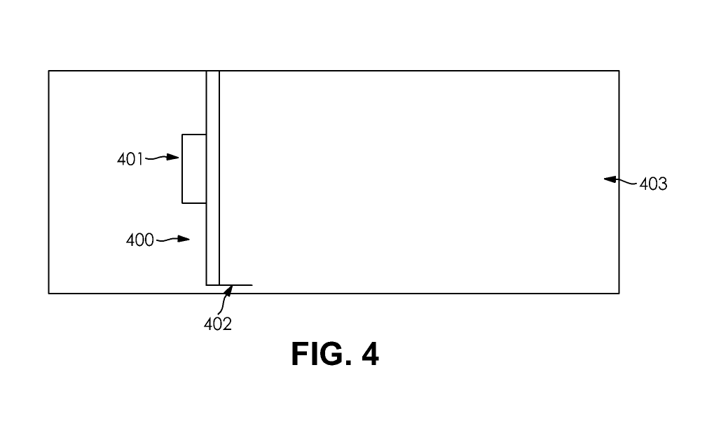

FIG. 4 is an example of an air contact reducer for use on a solid object. A solid object 403 may be, for example, a loaf of bread or a block of cheese. An air contact reducer 400 may be inserted into the solid object 403. A handle 401 may be used to push the air contact reducer 400 further on the solid object 403 as more of the contents is consumed. The air contact reducer 400 may have at least one L-shaped support 402 to go under at least one side of the solid object 403. The at least one L-shaped support 402 may prevent the solid object 403 from tipping over. The air contact reducer 400 may have more than one support, resulting in a T-shaped support.

The air contact reducer may stop at any level of a storage container or solid object, acting as a movable barrier. In contrast to other solutions, the air contact reducer may not damage or lose sealing like a vacuum seal might and it may not accidentally be left open or poorly closed like reusable bags (which are rarely reused). The air contact reducer is a single piece that may adapt to any size container and may easily reused.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An air contact reducer for food storage containers, the air contact reducer comprising:
a pliable circle; and
a handle in the middle of the pliable circle;
wherein the pliable circle has a thin outer diameter and a thick inner diameter.

2. The air contact reducer of claim 1, wherein the pliable circle is plastic.

3. The air contact reducer of claim 1, wherein the pliable circle is rubber.

4. The air contact reducer of claim 1, wherein the thin outer diameter is 0.020 inches.

5. The air contact reducer of claim 1, wherein the thick inner diameter is at least 0.125 inches.

6. The air contact reducer of claim 1, wherein the thin outer diameter ranges from 0.5-1.5 inches in length.

7. The air contact reducer of claim 6, wherein the thin outer diameter has cuts every 0.5 inches.

8. The air contact reducer of claim 1, wherein the shape of the handle is a circle.

9. An air contact reducer for food storage containers, the air contact reducer comprising:
a pliable rectangle; and
a handle in the middle of the pliable rectangle;
wherein the pliable rectangle has a support piece.

10. The air contact reducer of claim 9, wherein the pliable rectangle is plastic.

11. The air contact reducer of claim 9, wherein the pliable rectangle is rubber.

12. The air contact reducer of claim 9, wherein the support piece is an L-shaped support.

13. The air contact reducer of claim 9, wherein the support piece is T-shaped.

14. The air contact reducer of claim 1, wherein the shape of the handle is a rectangle.
